(19) United States
(12) Patent Application Publication
(10) Pub. No.: US 2026/0338738 A1
(43) Pub. Date: Oct. 29, 2026

(54) Inspection System and Method for Producing Inspection System

(71) Applicant: Hitachi GE Vernova Nuclear Energy, Ltd., Hitachi-shi (JP)

(72) Inventors: Takumi YAMADA, Tokyo (JP); Masahiro Miki, Tokyo (JP); Takehiro Ishii, Ibaraki (JP)

(21) Appl. No.: 19/658,842

(22) Filed: Apr. 27, 2026

(30) Foreign Application Priority Data
Apr. 28, 2025 (JP) 2025-074049

(51) Int. Cl. G01N 29/24

(52) U.S. Cl. CPC G01N 29/2412

(57) ABSTRACT

An inspection system includes: a sensor unit including an ultrasonic sensor placed on a surface of a subject and a sensor coil electrically connected to the ultrasonic sensor; and a metallic lagging plate covering the subject and the sensor unit. The metallic lagging plate has an opening formed at a position facing the sensor coil; and a slit formed extending from the opening to an end of the metallic lagging plate.

### CROSS-REFERENCE TO RELATED APPLICATIONS

This application claims priority to Japanese Patent Application No. 2025-074049, filed on Apr. 28, 2025, the entire contents of which are incorporated herein by reference.

### BACKGROUND OF THE INVENTION

### Field of the Invention

The present invention relates to an inspection system and a method for producing an inspection system.

### Description of the Related Art

As a background art of the present technical field, Summary of JP2018-205225A states that "[Object] To provide a sensor system which can detect a thickness reduction, a crack, or the like of a pipe or a container provisionally covered with a thick coating member through ultrasonic inspection without attachment and detachment of the coating member. [Solution] A sensor system 1 used for nondestructive inspection includes a sensor 20 attached to a surface of an inspection target 42, a sensor coil 21 that is electrically connected to the sensor 20 via a first cable 22, a first electromagnetic wave blocking member 23 that is disposed between the surface of the inspection target 42 and the sensor coil 21, a sensor side coil 3 that is disposed to face the sensor coil 21 with a gap and is coupled to the sensor coil 21 through electromagnetic induction, and a probe side coil 2 that is disposed to be separated from the sensor side coil 3 and is electrically connected to the sensor side coil 3 via a second cable 4." The description in this literature is incorporated as part of the present specification.

In the aforementioned technique, there is a demand for achieving nondestructive inspection with a much simpler structure.

### SUMMARY OF THE INVENTION

The present invention was made in view of the above circumstances, and has an object to provide an inspection system capable of achieving nondestructive inspection with a simple structure, and a method for producing such an inspection system.

In order to achieve the above object, an inspection system of the present invention includes: a sensor unit including an ultrasonic sensor placed on a surface of a subject and a sensor coil electrically connected to the ultrasonic sensor; and a metallic lagging plate covering the subject and the sensor unit. The metallic lagging plate has an opening formed at a position facing the sensor coil; and a slit formed extending from the opening to an end of the metallic lagging plate.

According to the present invention, it is possible to perform nondestructive inspection with a simple structure.

### BRIEF DESCRIPTION OF THE DRAWINGS

FIG. 1 is a schematic diagram of an inspection system in a first embodiment.

FIG. 2 is a diagram showing an example in which multiple metallic lagging plates are applied in the first embodiment.

FIG. 3 is a schematic diagram of main components of an inspection system according to a first comparative example.

FIG. 4 is a schematic diagram of main components of an inspection system according to a second comparative example.

FIG. 5 is a schematic diagram of main components of an inspection system according to a third comparative example.

FIG. 6 is a schematic diagram of main components of the inspection system according to the first embodiment.

FIG. 7 is an explanatory diagram of a manufacturing process and so forth of the inspection system according to the first embodiment.

FIG. 8 is a schematic diagram of a metallic lagging plate and other components in a second embodiment.

FIG. 9 is a schematic diagram of a metallic lagging plate and other components in a third embodiment.

### DETAILED DESCRIPTION OF THE EMBODIMENTS

### Overview of Embodiments

The nondestructive inspection technique covers techniques for enabling nondestructive inspection of objects such as structures and products. Among these, ultrasonic inspection techniques are widely used in industry because they are capable of performing low-cost and simple measurement of internal conditions of a target object. In nuclear power plants, thermal power plants, and the like, ultrasonic nondestructive inspection is performed at regular intervals to evaluate the soundness of structures such as containers and pipes. An example thereof is pipe wall thinning inspection, which involves measuring the wall thickness of a pipe at regular intervals, thereby determining how much the pipe wall is thinned and evaluating the remaining lifespan of the pipe.

In ultrasonic wall thickness measurement, by directly pressing an ultrasonic sensor against a pipe, an inspector is enabled to measure the wall thickness right below the sensor. On the other hand, most pipes are covered with heat insulation materials and lagging plates for holding the heat insulation materials. Therefore, when using the method including pressing an ultrasonic sensor against a pipe, an inspector has to remove the lagging plate and the heat insulation material once, directly press the ultrasonic sensor against the pipe to measure the wall thickness, and then reattach the heat insulation material and the lagging plate to the pipe. In addition, when a pipe is located at a high position, scaffolding is required for the inspector to access the pipe, which inevitably involves additional work for assembling and dismantling the scaffolding before and after the inspection. The nuclear power plant where a huge number of pipes, containers, and others are to be inspected, in particular, requires a significant amount of time and personnel for the above ancillary work associated with the inspection.

In a technique to which JP2018-205225A mentioned above is applied, it is conceivable to pre-install an ultrasonic sensor on a subject under a heat insulation material, thereby enabling ultrasonic inspection to be performed without removing the heat insulation material. Specifically, it is conceivable to enable non-contact ultrasonic inspection to be performed by driving the ultrasonic sensor pre-installed on the surface of the subject via electromagnetic induction between coils. More specifically, the ultrasonic sensor attached to the surface of the subject is installed, a sensor coil is electrically connected to the ultrasonic sensor, and a relay coil capable of coupling to the sensor coil through electromagnetic induction is provided outside a heat insulation material and a metallic lagging plate. When an inspection probe internally including transmitting and receiving coils is held over this relay coil, the ultrasonic sensor on the surface of the subject can be driven without contact, so that ultrasonic inspection can be performed without removing the heat insulation material.

Here, in the technique to which JP2018-205225A is applied, the reason for adopting the structure in which the relay coil is extended to the outside of the metallic lagging plate is to prevent the metallic lagging plate from shielding the electromagnetic induction between the coils. In general, when a conductor is present in an alternating magnetic field, eddy currents are generated on the surface of the conductor, the eddy currents generating a magnetic field in such a direction as to hinder changes in the alternating magnetic field. Therefore, when a metallic lagging plate is present between coils, the degree of coupling through the electromagnetic induction is so greatly reduced that it is difficult to drive the ultrasonic sensor. Thus, the above problem is solved by providing the relay coil establishing cable connection between the inside and the outside of the metallic lagging plate as described above.

However, the technique to which JP2018-205225A is applied employs the structure in which the cable and the relay coil are extended to the outside of the lagging plate, which complicates on-site work for sensor installation. Specifically, concerns arise such as the risk of cable breakage and the increased complexity of work of attaching the heat insulation material and the lagging plate. In view of this, embodiments described below aim to realize a non-contact ultrasonic inspection system via a metallic lagging plate which allows easy on-site sensor installation.

To this end, in the embodiments described below, a system includes an ultrasonic sensor placed on a surface of a subject and a sensor coil electrically connected to the ultrasonic sensor, and, in a metallic lagging plate, an opening facing the sensor coil and a slit connecting the opening and a metallic lagging plate joint are formed. Thus, such simple processing of the metallic lagging plate makes it possible to significantly reduce electromagnetic induction interference caused by eddy currents generated on the surface of the metallic lagging plate. As a result, the relay coil is not necessary any more, which makes it possible to achieve a non-contact ultrasonic inspection system which allows easy on-site sensor installation.

### First Embodiment

### Structure of First Embodiment

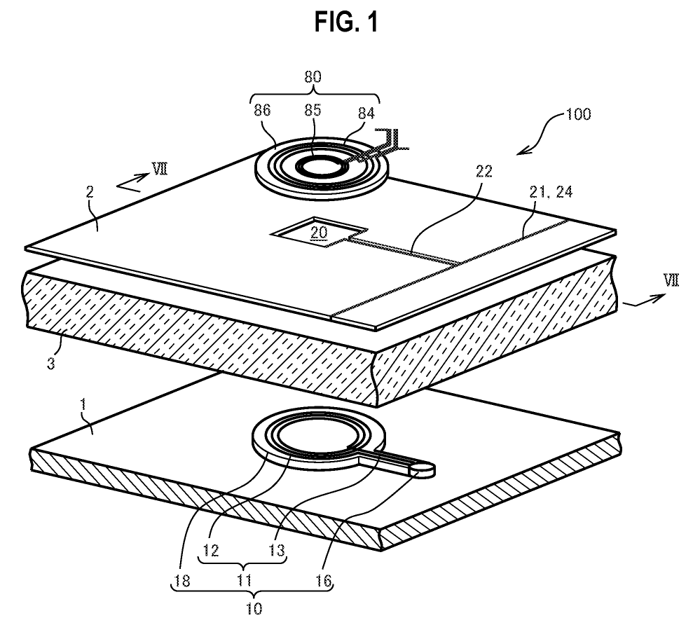

FIG. 1 is a schematic diagram of an inspection system 100 in a first embodiment.

In FIG. 1, the inspection system 100 includes a subject 1, a metallic lagging plate 2, a heat insulation material 3, a sensor unit 10, and an inspection probe 80.

The subject 1 is, for example, a cylindrical pipe made of carbon steel, stainless steel, or the like. FIG. 1 shows a portion of the subject 1 as a flat-plate-shaped object. Since the surface of the subject 1 becomes hot, its outer circumference is covered with the heat insulation material 3. The heat insulation material 3 is, for example, calcium silicate, rock wool, or the like with a thickness of several tens of millimeters, and is installed in close contact with the subject 1. In addition, an outer circumference of the heat insulation material 3 is covered with the metallic lagging plate 2. The metallic lagging plate 2 is, for example, an aluminum plate with a thickness of 1 mm or less.

The sensor unit 10 is attached to a surface of the subject 1. The sensor unit 10 includes an electromagnetic wave shielding member 18, a sensor coil 11, and an ultrasonic sensor 16. The ultrasonic sensor 16 and the electromagnetic wave shielding member 18 are attached to the surface of the subject 1. The sensor coil 11 is attached to a surface of the electromagnetic wave shielding member 18.

The sensor coil 11 includes a coil section 12 and a connecting section 13. The coil section 12 is a section in which a conductor wire is wound. The connecting section 13 is a conductor wire that electrically connects the coil section 12 and the ultrasonic sensor 16. The ultrasonic sensor 16 is a piezoelectric oscillator capable of transmitting and receiving ultrasonic waves to and from the inside of the subject 1. As the conductor wires applied to the sensor coil 11, the ultrasonic sensor 16, and the electromagnetic wave shielding member 18, those described in aforementioned JP2018-205225A may be used.

The metallic lagging plate 2 is formed by bending a rectangular metallic plate into a cylindrical shape and connecting two straight opposing sides of the metallic plate together with an insulator 24 interposed in between. The portion where the two opposing sides are connected is called a lagging plate joint 21. However, FIG. 1 shows a portion of the metallic lagging plate 2 as a flat-plate-shaped object. In the metallic lagging plate 2, an opening 20 punched out in a rectangular (for example, square) shape is formed. The opening area of this opening 20 is set to a value smaller than an inner diameter area of a transmitting coil 84 (to described later in detail). Moreover, in the metallic lagging plate 2, a portion having a narrow width while extending from the opening 20 to the lagging plate joint 21 constituted by the ends of the metallic lagging plate 2 is punched out, so that a slit 22 is formed. The slit 22 has a finite width and forms an air layer, and has a gap structure across which both sides of the metallic lagging plate 2 can be kept out of contact with each other.

The inspection probe 80 includes the transmitting coil 84, a receiving coil 85, and a base plate 86. The base plate 86 is a disc-shaped heat insulator. The transmitting coil 84 and the receiving coil 85 are each formed by winding a conductor wire in a ring shape and are mounted concentrically on the surface of the base plate 86. The transmitting coil 84 and the receiving coil 85 are connected to a pulse generator and a receiver (not shown), respectively. Note that the numbers of turns and diameters of the sensor coil 11, the transmitting coil 84, and the receiving coil 85 shown in FIG. 1 are merely examples and should be appropriately designed according to a subject to be inspected.

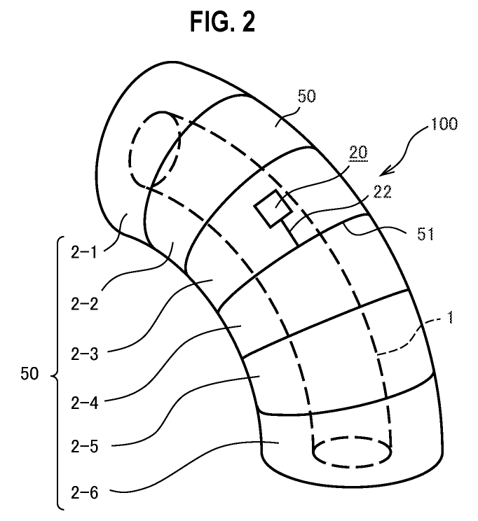

FIG. 2 is a diagram showing an example in which multiple metallic lagging plates are applied in the first embodiment.

In FIG. 2, a subject 1 is curved in an arc shape, and its circumference is covered with an elbow lagging plate 50. The elbow lagging plate 50 is formed as sectional elbows in which multiple cylindrical metallic lagging plates 2-1 to 2-6 are joined together. Each of the ends of the metallic lagging plates 2-1 to 2-6 is finished by bead processing. An insulator (not shown) is inserted into a joint portion between the metallic lagging plates 2-3 and 2-4, thereby forming a connecting section 51.

In other words, the metallic lagging plates 2-3 and 2-4 are insulated from each other at the connecting section 51. This connecting section 51 is equivalent to the lagging plate joint 21 in FIG. 1. In the examples shown in FIGS. 1 and 2, the slits 22 have the straight line shapes, but the shape of the slit 22 is not limited to these, and may be, for example, a curved shape or wavy shape.

In the foregoing structures, in order to inspect the subject 1, the inspection probe 80 is first placed at a position facing the coil section 12 of the sensor unit 10. Then, when the pulse generator (not shown) applies a pulse voltage to the transmitting coil 84, the pulse voltage is applied to the ultrasonic sensor 16 through electromagnetic induction between the transmitting coil 84 and the sensor coil 11. As a result, the ultrasonic sensor 16 transmits ultrasonic waves to the inside of the subject 1. The ultrasonic waves transmitted are reflected from various parts in the subject 1, and the reflected ultrasonic waves return to the ultrasonic sensor 16. The ultrasonic sensor 16 generates a pulse voltage according to the reflected ultrasonic waves. The pulse voltage thus generated appears as an induced voltage across the receiving coil 85 generated by the electromagnetic induction between the sensor coil 11 and the receiving coil 85.

### Comparative Examples

As described above, the sensor unit 10 and the inspection probe 80 can transmit and receive signals at a certain distance apart. If the metallic lagging plate 2 is not present, only a material that hardly affects electromagnetic induction, such as the heat insulation material 3, is present in a gap between the sensor unit 10 and the inspection probe 80. In this state, the sensor unit 10 and the inspection probe 80 can transmit and receive signals without any particular problems. On the other hand, if a conductor with a sufficiently large surface area, such as the metallic lagging plate 2, is present between the sensor unit 10 and the inspection probe 80, this conductor, that is, the metallic lagging plate 2 may interfere with transmission and reception of signals. To explain the principle of how to avoid such interference in the first embodiment, various comparative examples will be described.

FIG. 3 is a schematic diagram of main components of an inspection system according to a first comparative example.

A structure of the first comparative example is the same as in the first embodiment (see FIG. 1) except for a structure of a metallic lagging plate 2. The first comparative example is different from the first embodiment in that the opening 20 and the slit 22 are not formed in the metallic lagging plate 2. Here, FIG. 3 only shows the transmitting coil 84 and the metallic lagging plate 2 and omits the other elements. When a pulse current flows through the transmitting coil 84, a magnetic flux 31 is generated around the transmitting coil 84. Then, when the magnetic flux 31 reaches the metallic lagging plate 2, eddy currents 32 are generated on the surface of the metallic lagging plate 2. The eddy currents 32 are formed coaxially and concentrically with the magnetic flux 31. The magnitude of the eddy currents 32 is large at a position with high magnetic flux density, i.e., in the proximity of the transmitting coil 84.

The eddy currents 32 generate a magnetic field in such a direction as to cancel out the magnetic flux 31 produced by the transmitting coil 84, so that the magnetic flux 31 from the transmitting coil 84 is shielded by the metallic lagging plate 2. Therefore, when the metallic lagging plate 2 is present between the sensor unit 10 (see FIG. 1) and the inspection probe 80, the power supply to the ultrasonic sensor 16 through electromagnetic induction is significantly reduced, making non-contact measurement difficult.

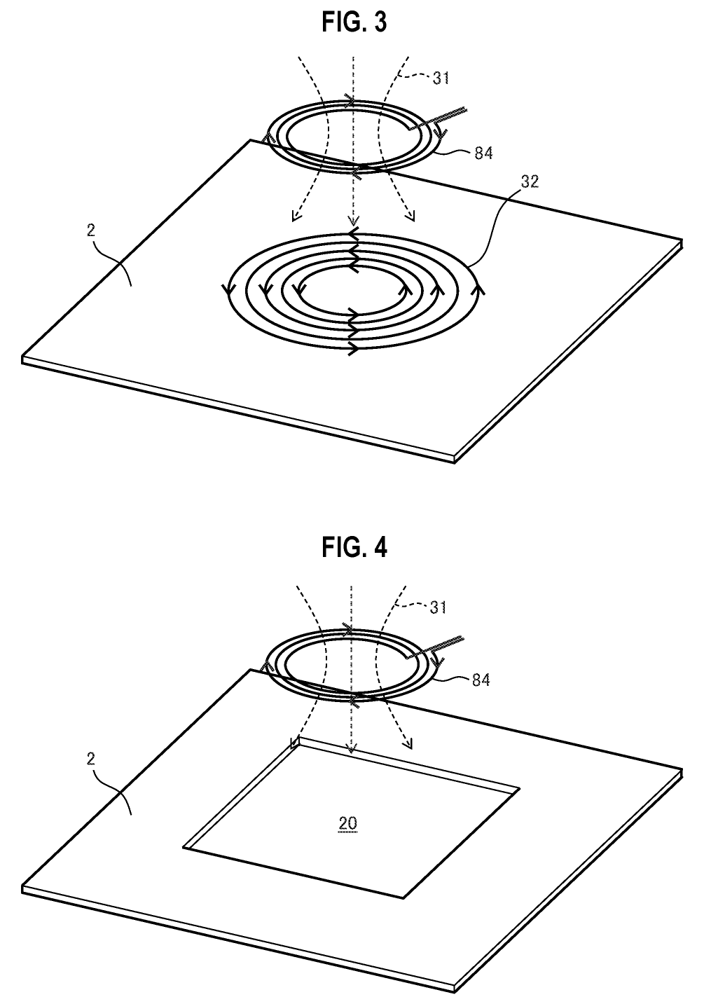

FIG. 4 is a schematic diagram of main components of an inspection system according to a second comparative example.

A structure of the second comparative example is the same as in the first embodiment (see FIG. 1) except for a structure of a metallic lagging plate 2. The second comparative example is different from the first embodiment in that an opening 20 larger than that in the first embodiment is formed and a slit 22 is not formed in the metallic lagging plate 2. Also, FIG. 4 only shows the transmitting coil 84 and the metallic lagging plate 2 and omits the other elements. In the second comparative example, as well, when a pulse current flows through the transmitting coil 84, a magnetic flux 31 is generated around the transmitting coil 84. In the second comparative example, since there is no conductor in the proximity of the transmitting coil 84, almost no eddy currents are generated. Therefore, it is possible to perform non-contact measurement through the opening 20 of the metallic lagging plate 2.

However, in the second comparative example, since the area of the opening 20 has to be formed to be larger than the inner diameter area of the transmitting coil 84, there are problems that the function of holding the heat insulation material 3 (see FIG. 1) is reduced and it is difficult to place multiple sensor units 10 in close proximity. Also, as an alternative to avoid the generation of eddy currents itself, it is conceivable to apply a non-metallic lagging plate instead of the metallic lagging plate 2. With a non-metallic lagging plate applied, it is possible to perform non-contact measurement through electromagnetic induction. However, in nuclear power plants, particularly high safety is required in terms of the strength, flame retardancy, and the like of the lagging plate. In this respect, there is a problem that a non-metallic lagging plate does not necessarily satisfy the necessary functions.

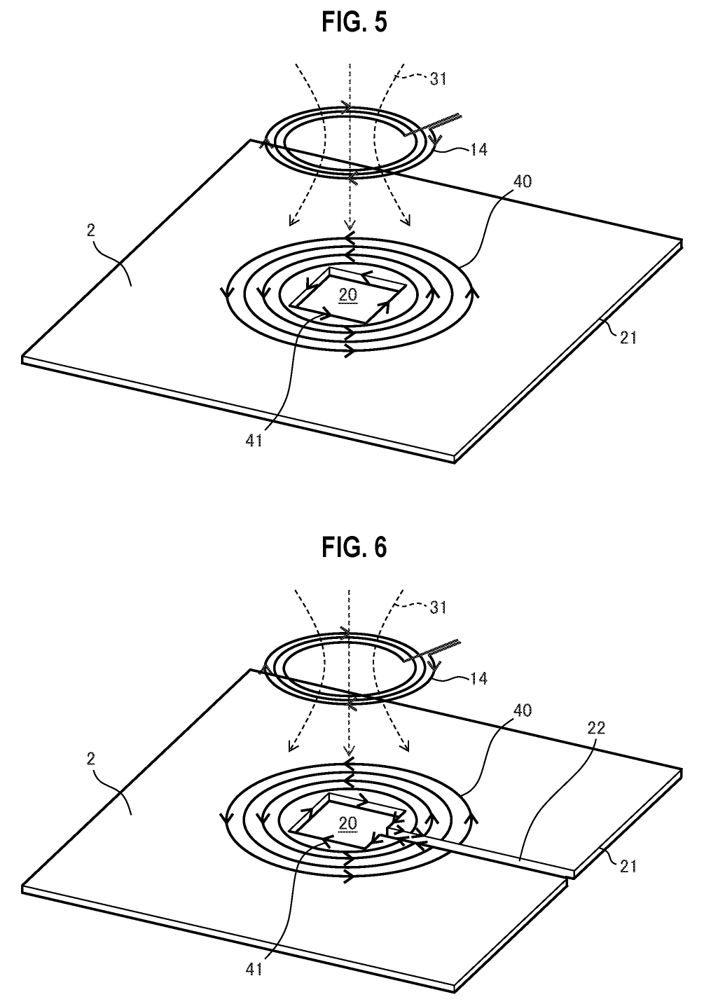

FIG. 5 is a schematic diagram of main components of an inspection system according to a third comparative example.

A structure in the third comparative example is the same as in the first embodiment (see FIG. 1) except for a structure of a metallic lagging plate 2. The third comparative example is different from the first embodiment in that an opening 20 with the same dimensions as in the first embodiment is formed but a slit 22 is not formed in the metallic lagging plate 2. Among eddy currents generated, eddy currents 40 with diameters larger than the opening 20 are not affected by the opening 20 and flow along nearly circular paths. On the other hand, an eddy current 41 near the opening 20 flow along a path detouring around the opening 20. This is because the conductivity of air and the conductivity of metal are different by 6 orders of magnitude and the eddy current 41 flows along a path with lower resistance. Although the generation of eddy currents can be reduced by an amount by which the area of the metallic lagging plate 2 is reduced by the opening 20, the eddy currents 40 and 41 flow in such a direction as to cancel out the magnetic flux 31, making it difficult to perform non-contact measurement through the metallic lagging plate 2.

### Operation in First Embodiment

Next, an operation in the first embodiment will be described.

FIG. 6 is a schematic diagram of main components of the inspection system 100 according to the first embodiment.

In the metallic lagging plate 2 in the first embodiment, the opening 20 and the slit 22 are formed as described above. Since the slit 22 is the air layer, the eddy currents 40 around the opening 20 cannot flow through the slit 22 and are electrically interrupted by the slit 22. In other words, the eddy currents 40 cannot form concentric loops. A path through which the interrupted eddy currents flow is a detour path extending from one side of the slit 22 to the opposite side of the slit 22 through edges of the opening 20.

Here, an eddy current 41 passing through the edges of the opening 20 flows in a direction opposite to the direction of the eddy currents 40 located at a distance from the opening 20. In the shown example, the eddy current 41 is clockwise and the eddy currents 40 are counterclockwise. The slit 22 extends to the lagging plate joint 21. Since the electrical resistance at the lagging plate joint 21 is very high, no current flows through the lagging plate joint 21. For this reason, as described above, the eddy current 41 flows along the opening 20 and the slit 22.

In the example shown in FIG. 6, the eddy current 41 flows in the same direction as in the electric current flowing through the transmitting coil 84. Accordingly, the eddy current 41 does not cancel out the magnetic flux 31 generated by the transmitting coil 84, but rather plays a role like a secondary transmitting coil to assist the transmitting coil 84. With the operation described above, the metallic lagging plate 2, which has the structure including the combination of the opening 20 and the slit 22, significantly reduces the eddy currents' effect of shielding the magnetic flux, and enables easy achievement of non-contact measurement through electromagnetic induction via the metallic lagging plate 2.

### Manufacturing Process and So Forth in First Embodiment

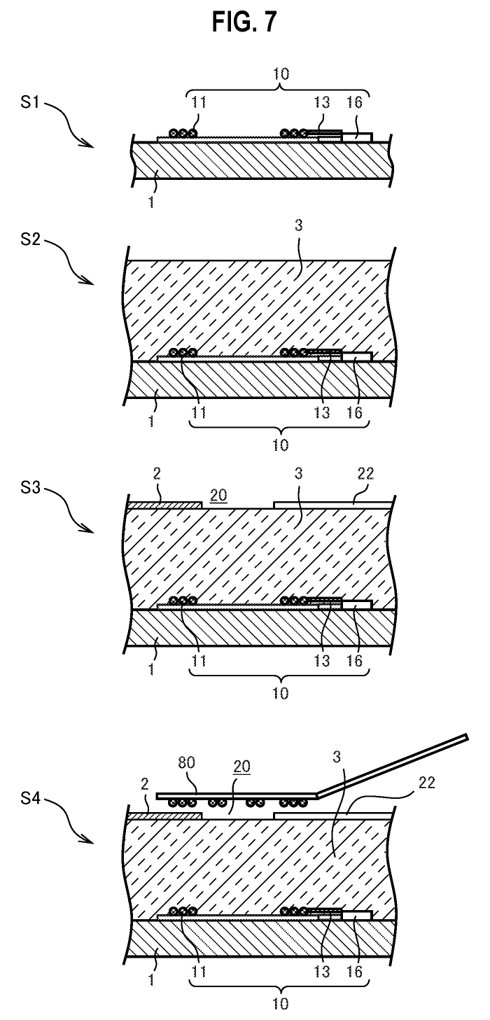

FIG. 7 is an explanatory diagram of a manufacturing process and so forth of the inspection system 100 according to the first embodiment.

Specifically, in FIG. 7, steps S1 to S3 show the course of the manufacturing process of the inspection system 100, and step S4 shows a usage state of the inspection system 100.

(Step S1)

In step S1, the sensor unit 10 is attached to a subject 1 to be inspected. More specifically, the ultrasonic sensor 16 may be first positioned at a predetermined measurement point, and the entire sensor unit 10 may be then bonded to the surface of the subject 1 with an adhesive. The connecting section 13 that electrically connects the ultrasonic sensor 16 and the sensor coil 11 may be designed with any length. Therefore, the sensor coil 11 may be located at any position where the opening 20 can be easily processed.

(Step S2)

In step S2, the heat insulation material 3 is attached to the subject 1 and the sensor unit 10 in the same manner as general heat insulator installation work. The heat insulation material 3 is pre-processed to match a geometric shape of the subject 1. In other words, in the heat insulation material 3, a space for the sensor unit 10 does not have to be reserved because the sensor unit 10 has a sufficiently thin structure. As the structure to which the technique of JP2018-205225A is applied, the structure is adopted in which the sensor coil and the relay coil are connected by the cable and the relay coil is assembled with the heat insulation material. This structure requires the relay coil to be attached to the heat insulation material during its pre-processing. However, in the present embodiment, since there is no need to insert any cable into the heat insulation material 3, it is possible to process and attach the heat insulation material 3 with a smaller number of man-hours.

(Step S3)

In step S3, the metallic lagging plate 2 is processed and attached. First, in the metallic lagging plate 2, the opening 20 is formed at a position to face the sensor coil 11 and the slit 22 is formed over a portion from the opening 20 to the lagging plate joint 21. Next, in the same manner as the general heat insulator installation work, the metallic lagging plate 2 is pre-processed according to the geometric shape of the heat insulation material 3 to be covered, and the metallic lagging plate 2 is attached to the heat insulation material 3 so that the opening 20 faces the sensor coil 11. In this step, it is most desirable to align the center of the opening 20 with the central axis of the sensor coil 11. However, these two do not necessarily have to be aligned with each other exactly, and the center of the opening 20 may be slightly offset from the central axis of the sensor coil 11. In other words, in the present embodiment, high-precision processing and installation of the metallic lagging plate 2 are not necessarily required, which further reduces the number of man-hours.

(Step S4)

In step S4, the subject 1 is inspected. This step S4 may be executed at any time after the completion of steps S1 to S3. Specifically, as shown in FIG. 7, the inspection probe 80 is brought close to the opening 20, and signals are transmitted and received through electromagnetic induction. Note that the heat insulation material 3 and the metallic lagging plate 2 do not need to be removed each time a measurement is taken. The inspection probe 80 is most desirably positioned so that the central axes of the transmitting coil 84 and the receiving coil 85 incorporated in the inspection probe 80 coincide with the central axis of the sensor coil 11, but may be misaligned to some extent. In addition, since an inspector can scan the inspection probe 80 around the opening 20 to find out the position where the signal strength is greatest, precise positioning is not required.

### Second Embodiment

Next, an inspection system according to a second embodiment will be described. A structure of the inspection system according to the second embodiment is the same as in the first embodiment (see FIG. 1), except for a structure of a metallic lagging plate 2. In the description of embodiments, the same reference signs are assigned to components corresponding to those in the other foregoing embodiment, and their descriptions may be omitted.

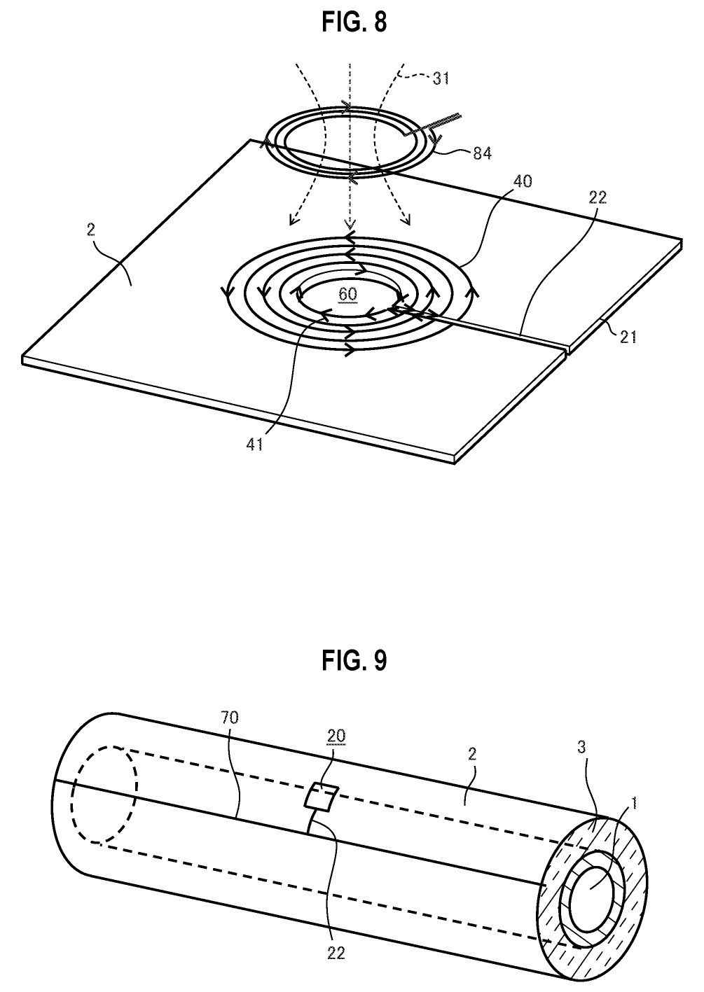

FIG. 8 is a schematic diagram of the metallic lagging plate 2 and other components in the second embodiment.

The metallic lagging plate 2 in the second embodiment is different in that a circular opening 60 is formed in place of the rectangular opening 20 (see FIG. 1) in the first embodiment. In the present embodiment, as well, an eddy current 41 passing through an edge of the opening 60 flows in a direction opposite to a direction of eddy currents 40 located at a distance from the opening 60.

Since the eddy current 41 plays a role like a secondary transmitting coil to assist the transmitting coil 84, it is more preferable that the shape of the eddy current 41 be as close as possible to the shapes of the transmitting coil 84 and the sensor coil 11 (see FIG. 1). In the present embodiment, since the sensor coil 11, the transmitting coil 84, and the receiving coil 85 are circular, the circular shape of the opening 60 produces an effect of reducing a loss, as compared to the first embodiment. However, since the opening 60 can achieve the desired function as long as it has a certain opening area, the shape of the opening 60 may be polygonal.

### Third Embodiment

Next, an inspection system according to a third embodiment will be described. A structure of the inspection system according to the third embodiment is the same as in the first embodiment (see FIG. 1), except for a structure of a metallic lagging plate 2.

FIG. 9 is a schematic diagram of the metallic lagging plate 2 and other components in the third embodiment.

In the third embodiment, a subject 1 is in a straight pipe shape, and the metallic lagging plate 2 is wound around the subject 1 and a heat insulation material 3 in a manner curved along a circumferential direction of them. Two opposing sides of the metallic lagging plate 2 are seam-jointed at a joint 70. This joint 70 is equivalent to the lagging plate joint 21 in FIG. 1. According to the present embodiment, even in a straight-pipe-shaped lagging plate or the like in which a joint extending in the circumferential direction of the subject 1 is very small (or is not present at all), the sensor unit 10 and the inspection probe 80 (see FIG. 1) are enabled to transmit and receive signals through electromagnetic induction.

### Modifications

The present invention is not limited to the foregoing embodiments, but may be modified in various ways. The foregoing embodiments are described merely as examples for facilitating understanding of the present invention, and the present invention should not be limited to those including all the described constituent elements. Moreover, some of constituent elements in a certain embodiment may be replaced with constituent elements in another embodiment, or the constituent elements in a certain embodiment may be supplemented with some constituent elements in another embodiment. Furthermore, some of the constituent elements in each embodiment may be deleted or altered by replacement/addition with other constituent elements. In addition, control lines and information lines shown in the drawings are those considered necessary for explanation, and do not necessarily represent all control lines and information lines required in products. In practice, almost all constituent elements may be considered to be connected to each other. An example of a possible modification to the above embodiments is as follows.

(1) In each of the above embodiments, the opening 20 or 60 and the slit 22 constitute the air layer formed by cutting out the metallic lagging plate 2. Instead, a heat insulation material may be embedded in the opening 20 or 60 and the slit 22.

### Effects of Embodiments

According to the foregoing embodiments, the inspection system 100 includes: the sensor unit 10 including the ultrasonic sensor 16 placed on the surface of the subject 1 and the sensor coil 11 electrically connected to the ultrasonic sensor 16; and the metallic lagging plate 2 covering the subject 1 and the sensor unit 10 and having the opening 20 or 60 formed at the position facing the sensor coil 11 and the slit 22 formed extending from the opening 20 or 60 to an end of the metallic lagging plate 2 as described above.

This structure enables nondestructive inspection with a simple structure while suppressing eddy currents generated in the metallic lagging plate 2.

Moreover, it is even more preferable that the slit 22 have a finite width and form an air layer. This increases the insulation level at the slit 22. Moreover, the inspection system 100 further includes the inspection probe 80 including the transmitting coil 84 configured to transmit signals to the sensor coil 11 through electromagnetic induction, and the receiving coil 85 configured to receive signals from the sensor coil 11 through electromagnetic induction. It is even more preferable that the opening 20 or 60 have a circular or polygonal shape with an area smaller than the inner diameter area of the transmitting coil 84. With the area of the opening 20 or 60 made smaller in this way, the strength of the metallic lagging plate 2 can be maintained.

Furthermore, it is even more preferable that the end of the metallic lagging plate 2 is connected to another portion of the metallic lagging plate 2 with the insulator 24 interposed in between, thereby forming the lagging plate joint 21. The lagging plate joint 21 formed in this way makes it possible to further maintain the strength of the metallic lagging plate 2.

What is claimed is:

1. An inspection system comprising:
a sensor unit including an ultrasonic sensor placed on a surface of a subject and a sensor coil electrically connected to the ultrasonic sensor; and
a metallic lagging plate covering the subject and the sensor unit,
wherein the metallic lagging plate has an opening formed at a position facing the sensor coil; and a slit formed extending from the opening to an end of the metallic lagging plate.

2. The inspection system according to claim 1, wherein the slit has a finite width and forms an air layer.

3. The inspection system according to claim 2, further comprising: an inspection probe including a transmitting coil configured to transmit a signal to the sensor coil through electromagnetic induction; and a receiving coil configured to receive a signal from the sensor coil through electromagnetic induction,
wherein the opening has a circular or polygonal shape with an area smaller than an inner diameter area of the transmitting coil.

4. The inspection system according to claim 3,
wherein the end of the metallic lagging plate is connected to another portion of the metallic lagging plate with an insulator interposed in between, thereby forming a lagging plate joint.

5. A method for producing an inspection system comprising:
placing a sensor unit on a surface of a subject, the sensor unit including an ultrasonic sensor and a sensor coil electrically connected to the ultrasonic sensor;
covering the subject and the sensor unit with a heat insulation material; and
attaching, to the heat insulation material, a metallic lagging plate, which has an opening and a slit formed extending from the opening to an end of the metallic lagging plate, so that the metallic lagging plate covers the subject, the sensor unit, and the heat insulation material while the opening is positioned facing the sensor coil.
